(19) United States
(12) Patent Application Publication
(10) Pub. No.: US 2017/0015586 A1
(43) Pub. Date: Jan. 19, 2017

(54) RECOVERY OF INTERMITTENT LOST HEAT

(71) Applicant: FIVES FCB, Villeneuve d'Ascq (FR)

(72) Inventor: Serge JORGET, Villeneuve d'Ascq (FR)

(21) Appl. No.: 15/124,383

(22) PCT Filed: Mar. 9, 2015
(86) PCT No.: PCT/FR2015/050565

§ 371 Date: Sep. 8, 2016

(30) Foreign Application Priority Data
Mar. 10, 2014 (FR) 14 51930

(51) Int. Cl. C04B 7/47; F27B 7/20; F27D 15/02; F27B 7/33; F27B 7/38

(52) U.S. Cl. CPC C04B 7/475; F27B 7/33; F27B 7/383; F27D 15/02; F27B 7/20; C04B 2290/20

(57) ABSTRACT

A cement clinker manufacturing method implemented in a continuous production facility having at least one fuel combustion area for firing an inorganic raw material into hot clinker, then the hot clinker is cooled in: a first cooling step in a first cooler; and a second consecutive cooling step in a second cooler. The first cooling step is continually carried out by blowing an oxygen gas on the hot clinker to obtain partially cooled clinker, and all the heated oxygen gas, created by the first cooler, is sent to the combustion area for use as combustion gas by adjusting the amount of oxygen gas, blown in the first cooler, such as to cover the combustion gas needs of the facility without any excess; and the partially cooled clinker is stored in a storage chamber, and the second cooling step is intermittently carried out on the partially cooled clinker.

The invention relates to a cement clinker production method and a facility for the continuous production of cement clinker.

The invention relates more particularly to the problem of lost heat in such a method and facility.

Cement clinker production facilities generally comprise a rotary kiln, preceded in the direction of flow of the treated material by a cyclone preheater, and followed by a clinker cooler. These facilities consume substantial amounts of energy in the form of fuel, of the order of 3200 MegaJoules per tonne of clinker for modern plants.

Large quantities of hot exhaust fumes and gases are produced, and are brought into contact with the materials to exchange heat contained in the gases. Given technical and technological limitations on exchanges, the final fumes and gases still contain some of the heat provided by the fuel. On the upstream side considering the flow direction of the materials, combustion gases leave the cyclone preheater at a temperature between 300° C. and 400° C., carrying about 20% of the fuel energy with them. On the downstream side, an air flow known to an expert in the subject as the “excess air” flow, exits from the clinker cooler at a temperature typically between 200° C. and 300° C., carrying about 10% of the fuel energy with it.

The energy contained in the flue gases is usually used at least partially to dry raw materials. The energy contained in excess air from the cooler is not usually used directly in the cement production method. Experts in the subject are familiar with systems for recovery of lost heat from these gases that use exchangers to produce vapour (steam or hydrocarbon vapour), carried to a turbine to generate electricity.

It is known that the energy conversion efficiency can be improved by treating only a portion of excess air from the cooler, supplying only the part at a temperature higher than 400° C. to the heat exchanger, and abandoning recovery from the part at lower temperature; the heat conversion efficiency is improved, but the quantity of reused excess air is reduced.

Another way of improving the energy efficiency is essentially to use another heat quantity at a higher temperature, to supplement the heat in the excess air.

For example, document WO2009/156614 published by the applicant of this document, discloses a clinker production plant in which excess air at a temperature less than or equal to 300° C. cooperates with a steam generator, a second heat exchanger cooperates heat source at a higher temperature, in this case tertiary air at a temperature of at least 750° C., to superheat this steam. This superheated steam is carried to a turbine for generation of electricity. Such a solution that uses additional heat to supplement heat from the outlet air, increases the conversion efficiency. However, the calorific consumption of the plant is increased.

Another disadvantage of these heat recovery systems is that they are affected by operational fluctuations of the clinker production facility and cannot be fully optimized.

The purpose of this invention is to disclose a clinker production method and a cement clinker production facility to implement the method, that compensate the disadvantages mentioned above by increasing the overall efficiency of recovering lost heat.

More particularly, the purpose of this invention is to disclose such a method and such a facility, in which operation of the heat recovery system is only slightly affected by operational variations.

Other purposes and advantages will become clear after reading the following description that is given for guidance only and that is not in any way limitative.

To achieve this, the invention relates firstly to a cement clinker manufacturing method implemented in a continuous production facility having at least one fuel combustion zone for firing an inorganic raw material, in which the raw material is converted into clinker by firing, obtaining hot clinker, the hot clinker is then cooled in two successive steps, a first cooling step being carried out in a first cooler and a second cooling step being carried out in a second cooler.

In the method according to the invention

a first cooling step is carried out continuously by blowing an oxygenated gas onto the hot clinker to obtain partially cooled clinker, and all heated oxygenated gas output from the first cooler is transferred to said at least one combustion zone of said facility to be used as combustion gas by adjusting the amount of oxygenated gas blown in the first cooler so as to cover combustion gas needs of said facility without excess,

the partially cooled clinker is stored in a storage chamber of the second cooler or a storage chamber associated with this second cooler, and the second cooling step on the partially cooled clinker is controlled intermittently.

According to these optional features of the invention alone or in combination:

the heat given off by the clinker during the second cooling step is used to generate electrical energy;

electricity energy generation uses at least one second enthalpy source in combination with the heat transferred by the clinker during the second cooling step;

the availability of said second enthalpy source is variable and the second cooling step is started up at least during periods in which the power generated by the second enthalpy source is less than a predetermined threshold value;

the availability of said second enthalpy source is variable and the second cooling step is started up at least during periods in which the power generated by the second enthalpy source is more than a predetermined threshold value;

the second enthalpy source is solar;

the generation of electrical energy is associated with at least one second source of electrical energy with variable generation;

the second cooling step is started up at least during periods in which the power generated by the second source of electric energy is less than a threshold value;

the operating time of the second cooling step is less than 50% of the clinker production operation time of the facility.

According to one embodiment, in the second step the clinker is cooled by exchange with a fluid without direct contact between the clinker and the cooling fluid. Alternatively, in the second step the clinker may be cooled by exchange with a fluid brought into direct contact with the clinker.

According to one embodiment, the heated fluid downstream from the second heat exchanger cooperates with a heat exchanger to generate steam to power a turbine in the facility for the generation of electricity.

According to one embodiment, said continuous manufacturing facility comprises a cyclone preheater, possibly a precalcinator equipped with one or several burners, and a rotary kiln equipped with one or several burners, in which method the raw material is preheated in the cyclone preheater, possibly partially decarbonated in the precalcinator and then fired and transformed in the rotary kiln and in which said at least one combustion zone comprises the burner or burners of the rotary kiln, and possibly the burner or burners of the precalcinator.

According to one embodiment, the oxygenated gas is air. Alternatively, the oxygenated gas may be a gas enriched in oxygen, or depleted in oxygen.

The invention also relates to a continuous clinker production facility having at least one combustion zone of a fuel for firing an inorganic raw material, designed to transform the raw material into clinker by firing to obtain hot clinker, said facility having a first cooler and a second cooler in succession, arranged to cool the hot clinker in two successive steps, a first cooling step being carried out in said first cooler and a second cooling step being carried out in said second cooler.

According to the invention, said facility comprises:

a source of oxygenated gas to cool the materials in the first cooler,

gas lines arranged to convey the entire heated gas generated by the first cooler, to said at least one combustion zone of said facility to be used as combustion gases,

means for adjusting the quantity of oxygenated gas blown to the first cooler so as to cover combustion gas needs of said facility without excess,

and in which said second cooler comprises means for storage of partially cooled clinker after the first cooling step, said facility comprising means for intermittently controlling said second cooler.

According to optional features of the invention, taken alone or in combination:

the facility comprises a cyclone preheater, possibly a precalcinator equipped with one or several burners, and a rotary kiln equipped with one or several burners, and said at least one combustion zone comprises the burner or burners of the rotary kiln, and optionally the burner or burners of the precalcinator;

said facility comprises a device for generating electricity from the heat transferred by the clinker in the second cooler;

the second cooler exchanges heat between the partially cooled clinker and a fluid, and the electricity generating device comprises a heat exchanger and a turbine, the heat exchanger cooperating with the fluid heated by the clinker to generate steam used to supply said turbine.

The invention will be better understood after reading the following description accompanied by the appended drawings in which:

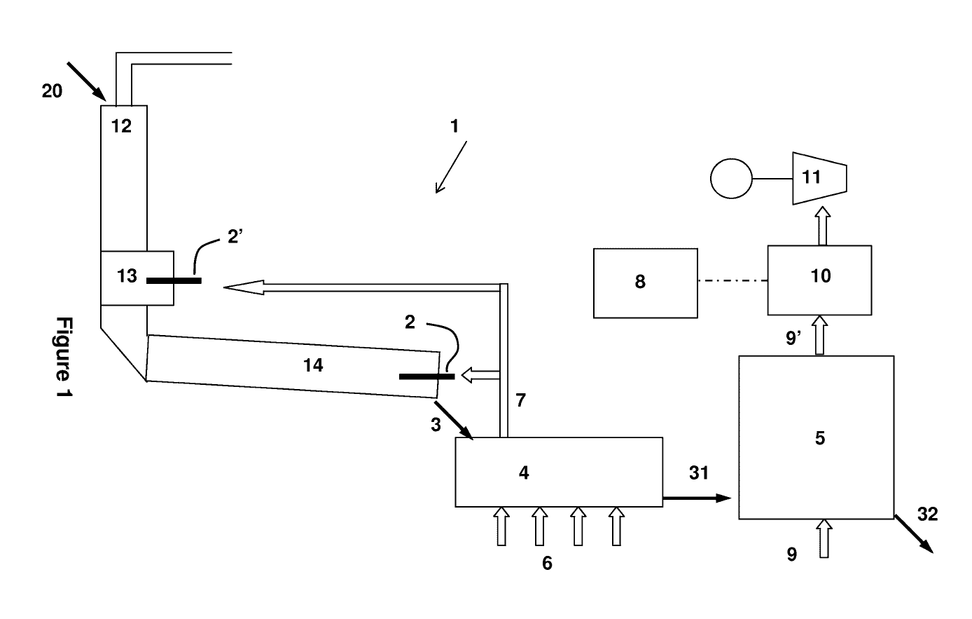

FIG. 1 is a view of a facility suitable for implementing the method according to one embodiment of the invention in which the generated electric power uses at least one second enthalpy source, combined with heat released by the clinker during the second cooling step;

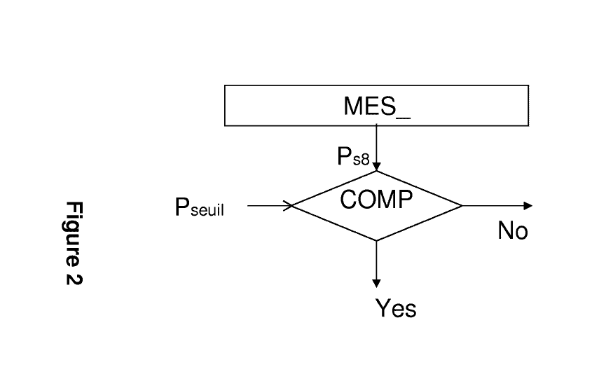

FIG. 2 is a diagram explaining intermittent operation of the second cooling step in the facility as shown in FIG. 1;

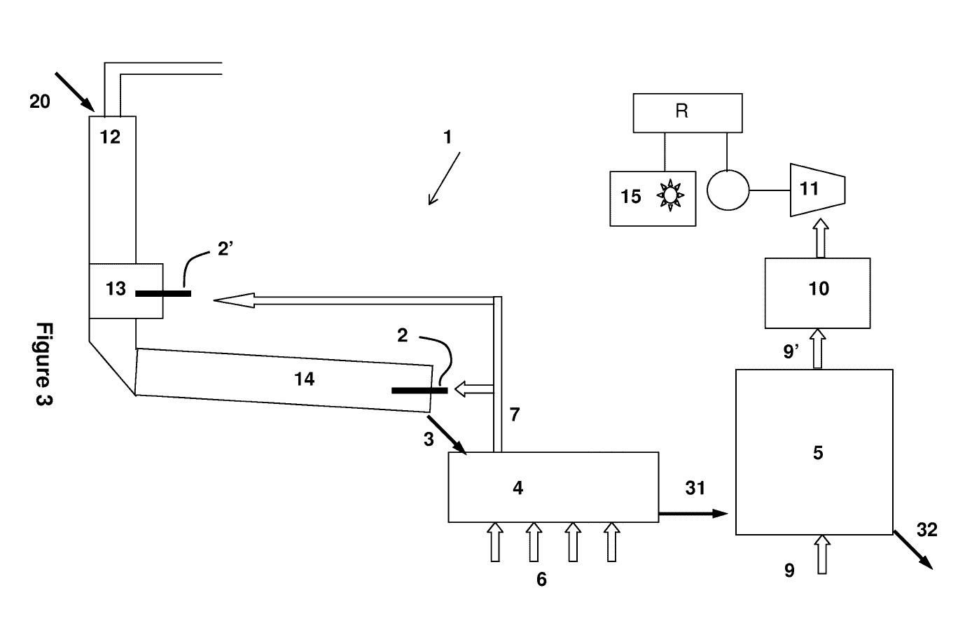

FIG. 3 is a view of a facility suitable for implementing a second embodiment of the method according to the invention in which the generation of electric energy is associated with a second variable source of generated electrical energy;

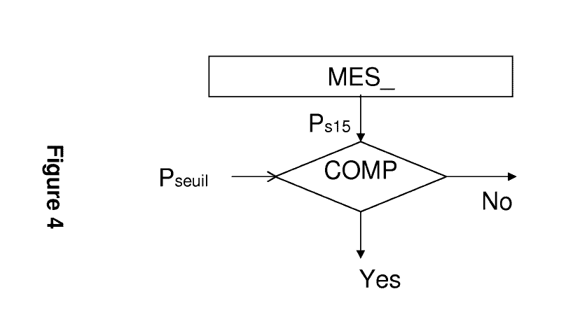

FIG. 4 is a diagram explaining intermittent operation of the second cooling step of the facility as shown in FIG. 2.

The invention relates firstly to a cement clinker manufacturing method implemented in a continuous production plant 1, having at least one combustion zone 2, 2′ of a fuel for firing an inorganic raw material, in which the raw material is transformed into clinker by firing to obtain hot clinker 3, the hot clinker 3 is then cooled in two successive steps, a first cooling step being implemented in a first cooler 4 and a second cooling step being implemented in a second cooler 5.

In the traditional manner, said continuous manufacturing facility may comprise a cyclone preheater 12, possibly a precalcinator 13 equipped with one or several burners 2′, and a rotary furnace 14 equipped with one or several burners 2. The hot gases outlet from the precalcinator 3 can supply the base of the cyclone preheater 12. Gases outlet from the rotary kiln 14 can possibly supply the cyclone preheater 12.

In such a facility, the raw material 20 is preheated in the cyclone preheater 12, possibly partially decarbonated in the precalcinator 13, and then baked and processed in the rotary kiln 14. In this facility, said at least one combustion zone comprises the burner or burners 2 of the rotary kiln 14, and possibly the burner or burners 2′ of the precalcinator 13.

In the method according to the invention, the first cooling step is done continuously by blowing an oxygenated gas 6 on the hot clinker to obtain the partially cooled clinker 31, and the entire heated oxygenated gas 7 generated by the first cooler 4 is routed to said at least one combustion zone 2,2′ of said facility to be used as combustion gas, in other words as an oxidizing gas. The first cooler 4 may be a grate cooler.

The quantity of oxygenated gas blown into the first cooler is also adjusted so as to cover combustion gas needs of said facility, without excess. Depending on the embodiment, this need for combustion gas includes the oxidant necessary for combustion of the fuel at the burner or burner 2 of the rotary kiln 14, and possibly in the case of a facility with precalcinator 13, the oxidant necessary for combustion of fuel at the burners or burners 2′ of the precalcinator 13.

The oxygenated gas may be air, or an oxygenated gas with depleted or enriched oxygen. In this description the terms “depleted” and “enriched” are relative to the oxygen content of ambient air (i.e. 21%).

In other words, the precise quantity of oxidizing gas required for the facility is blown into the first cooler 4, to obtain partially cooled clinker at the highest possible temperature at the outlet from the first cooler 31.

This temperature of the partially cooled clinker 31 can be approximately 400° C., for example between 350° C. and 450° C.

In addition, and according to an essential characteristic of the invention, the partially cooled clinker 31 is not continuously cooled in the second cooler, as is the case in facilities according to prior art with two successive coolers.

On the contrary, according to the invention, the partially cooled clinker 31 is stored in a storage chamber of the second cooler 5 or a storage chamber associated with this second cooler 5, and the second cooling step on the partially cooled clinker 31 is controlled intermittently.

Heat exchange conditions in the second cooling step implemented in the second cooler 5 can thus be controlled, this exchange is no longer dependent on fluctuations in the cement clinker production method, and depends especially on the produced flow of hot clinker.

Intermittent control of the second cooling step can give higher heat recovery efficiencies than the continuous cooling method.

As a first alternative, the clinker can be cooled in the second step by exchange with a fluid 9 brought into direct contact with the clinker, or as a second alternative it can be cooled without direct contact between the clinker and the cooling fluid: in the latter case the exchange can be made through a wall.

Intermittent control of the second cooling step makes it possible to control exchange conditions between the fluid 9 and the partially cooled clinker 31 to obtain a heated fluid 9′ after exchange with the clinker, for which the flow and the temperature can give higher heat recovery efficiencies.

According to one embodiment, the operating time of the second cooling step may be less than 50% of the clinker production operating time in the facility.

The fluid 9 may be a gas such as air when it will come into contact with the clinker. This fluid 9 may also be a liquid/vapour mixture when this mixture will not come into direct contact with the clinker.

By optimizing the conditions of this exchange, it may be possible to obtain a clinker 32 cooled to a temperature of between 30° C. and 10° C. above ambient temperature, downstream from the second cooling step. By comparison, in state-of-the-art facilities with continuous cooling, the clinker is usually cooled to a temperature of between 80° C. and 65° C. above ambient temperature.

The heated fluid 9′ can be used to generate electricity. When this fluid is a gas such as air, it can be fed into the primary of an exchanger 10, the secondary of the exchanger 10 generating steam under pressure fed into a turbine 11.

When this fluid 9 is a liquid/vapour mixture, the heated fluid 9′ can be steam to supply the turbine 11. In both cases, the turbine 11 drives a generator to generate electricity.

According to one embodiment illustrated non-limitatively in FIG. 1, the electric power generation uses another enthalpy in addition to the heat released by the clinker during the second cooling step, and in particular at least one second enthalpy source 8, for example from solar energy.

According to one embodiment, said second enthalpy source 8 may have variable availability. Advantageously, the second cooling step can be started up at least during periods in which the power Ps8 generated by the second enthalpy source 8 is less than a determined threshold value Pthreshold. The objective may he to ensure continuity of electricity production.

According to another alternative, the second cooling step can also be started up at least during periods in which the power Ps8 generated by the second enthalpy source 8 is more than a predetermined threshold value Pthreshold. In this case, the objective may be to maximize the conversion efficiency of electrical energy.

According to one embodiment illustrated non-limitatively in FIG. 3, the production of electric energy may be associated with at least one second source of electrical enemy 15, with variable production. This second source of electrical energy may be solar, for example it may be generated by a photovoltaic plant and/or by one or more wind turbines.

According to one embodiment, the second cooling step can be started up at least during periods in which the power Ps15 generated by the second electrical energy source 15 is less than a determined threshold value Pthreshold. The objective thus pursued can be to ensure continuous power generation.

According to another alternative, the second cooling step and therefore the production of associated electrical energy may be started up by an order from an electricity supplier.

In the case in which the supply and demand of electricity on the network R are unbalanced, the flexibility provided by the invention allows a temporary increase of the supply (or possibly a reduction of the demand), preferably during peak periods, by enabling production of electricity associated with the second cooling step.

This ability to satisfy the electricity demand or to smooth the load curve during peak periods) makes it possible to negotiate advantageous price conditions, for example for the purchase of electricity generated by the facility, or on the electricity contract.

The possibility made available by the invention to increase the energy conversion efficiency and/or to benefit from better pricing conditions can significantly reduce the return on investment time of the facility.

The invention also relates to a facility 1 for continuous production of clinker, suitable for implementation of the method. This facility comprises at least one combustion zone 2, 2′ of a fuel for firing an inorganic raw material, designed to transform the raw material into clinker by firing, obtaining hot clinker 3, said facility having a first cooler 4 followed by a second cooler 5 arranged to cool the hot clinker 3 in two successive steps, a first cooling step being carried out in said first cooler 4 and a second cooling step being carried out in said second cooler 5.

According to the invention, the facility comprises:

an oxygenated gas source 6 for cooling materials in the first cooler 4,

gas lines arranged to convey the entire heated gas generated by the first cooler 4, to said at least one combustion zone 2,2′ of said facility to be used as combustion gas,

means for adjusting the quantity of oxygenated gas blown in the first cooler so as to cover the combustion gas needs of said facility, without excess.

According to the invention, said second cooler 5 includes storage means for the partially cooled clinker 31 at the end of the first cooling step, said facility comprising means for intermittently controlling said second cooler 5.

The facility may comprise a cyclone preheater 12, possibly a precalcinator 13 equipped with one or several burners 2′, and a rotary furnace 14 equipped with one or several burners 2, and in which said at least one combustion zone comprises the burner or burners 2 of the rotary kiln 14, and optionally the burner or burners 2′ of the precalcinator 13.

The facility may include a device 10, 11 for generating electricity from heat released by clinker in the second cooler. For example, the second cooler exchanges heat between the partially cooled clinker 31 and a fluid 9. The electricity generation device may include a heat exchanger 10 and a turbine 11, the exchanger cooperating with the fluid 9′ heated by the clinker to generate steam used to supply said turbine 11.

### Example

Consider clink produced by the rotary kiln at a typical temperature of 1420° C. with an enthalpy of 1550 kJ/kg. This clinker is cooled by blowing air in a grate cooler. The best available technology of grate coolers for operation in a modern clinker firing line transfers 78% of the energy to the hot air necessary for combustion of the fuel used for production of the clinker. Therefore the clinker contains 341 kJ/kg after the first cooling step and its mean temperature is 385° C.

In a conventional method, as known in prior art, clinker is cooled to 65° C. above ambient temperature (assumed to be 20° C.) with a volume of 0.9 Nm³/kg air o which it transfers 279 kJ to produce outlet air at a temperature of 253° C. The typical efficiency of an electric energy conversion system for these temperature conditions is 17%, so that 1.3.18 kWh can be generated per tonne of clinker.

By comparison and with the method according to the invention, a counter-current can be set up in said second exchanger in which the air quantity is chosen so as to optimize the exchange, in which the clinker is cooled to 30° C. (10° C. above the ambient 20° C.), and air at 375° C., is produced (10° C. below the maximum temperature of the clinker). 308 kJ was transferred to 0.62 Nm³ of air to reach 375° C. The typical efficiency of an electric energy conversion system is 23% for these temperature conditions, so that 19.68 kWh can be generated per tonne of clinker. The increased generation of final energy is 50%.

### NOMENCLATURE

1. Continuous clinker production facility,
2, 2′. Combustion zones (facility 1)
3. Hot Clinker,
4. First cooler,
5. Second cooler,
6. Air (blown at first cooler)
7. Heated gases (outlet from the first cooler)
8. Second enthalpy source
9, 9 Fluid (upstream and downstream from the second cooler respectively)
10. Heat exchanger,
11. Turbine,
12. Cyclone preheater,
13. Precalcinator,
14. Rotary kiln,
15. Second electricity source,
20. Raw Material.

31. Partially cooled clinker (downstream from the first cooling step and upstream from the second cooling step),
32. Cooled clinker (downstream from the second cooling step).
R. Electricity network,
Pthreshold. Power threshold value,
Ps8. Instantaneous power of the second enthalpy source
Ps 15. Instantaneous power of the second electricity source.

1. Cement clinker manufacturing method implemented in a continuous production facility (1) having at least one fuel combustion zone (2, 2′) for firing an inorganic raw material, in which the raw material is converted into clinker by firing, obtaining hot clinker (3), the hot clinker (3) is then cooled in two successive steps, a first cooling step being carried out in a first cooler (4) and a second cooling step being carried out in a second cooler (5),
wherein:
the first cooling step is carried out continuously by blowing an oxygenated gas (6) onto the hot clinker to obtain partially cooled clinker, and all heated oxygenated gas (7) output from the first cooler (4) is transferred to said at least one combustion zone (2, 2′) of said facility to be used as combustion gas by adjusting the amount of oxygenated gas blown in the first cooler so as to cover combustion gas needs of said facility without excess,
the partially cooled clinker (31) is stored in a storage chamber of the second cooler (5) or a storage chamber associated with this second cooler, and the second cooling step on the partially cooled clinker is controlled intermittently.

2. Method according to claim 1, in which heat given off by the clinker during the second cooling step is used to generate electrical energy.

3. Method according to claim 2, in which electricity generation uses at least one second enthalpy source (8) in combination with the heat transferred by the clinker during the second cooling step.

4. Method according to claim 3, in which the availability of said second enthalpy source (8) is variable and in which the second cooling step is started up at least during periods in which the power generated (Ps8) by the second enthalpy source (8) is less than a predetermined threshold value (Pthreshold).

5. Method according to claim 3, in which the availability of said second enthalpy source is variable and in which the second cooling step is started up at least during periods in which the power generated (Ps8) by the second enthalpy source (8) is more than a predetermined threshold value.

6. Method according to claim 4, in which the second enthalpy source (8) is solar.

7. Method according to claim 2, in which the generation of electrical energy is associated with at least one second source of electrical energy (15) with variable generation.

8. Method according to claim 7, in which the second cooling step is started up at least during periods in which the power generated (Ps15) by the second source of electric energy (15) is less than a threshold value (Pthreshold).

9. Method according to claim 1, in which the operating time of the second cooling step is less than 50% of the clinker production operation time of the facility.

10. Method according to claim 2, in which in the second step, the clinker is cooled by exchange with a fluid (9) without direct contact between the clinker and the cooling fluid.

11. Method according to claim 1, in which in the second step, the clinker is cooled by exchange with a fluid (9) brought into direct contact with the clinker.

12. Method according to claim 2, in which the heated fluid (9′) downstream from the second heat exchanger cooperates with a heat exchanger (10) to generate steam to power a turbine (11) in the facility for the generation of electricity.

13. Method according to claim 1, in which said continuous manufacturing facility comprises a cyclone preheater (12), possibly a precalcinator (13) equipped with one or several burners (2′), and a rotary kiln (14) equipped with one or several burners (2), in which method the raw material (20) is preheated in the cyclone preheater (12), possibly partially decarbonated in the precalcinator (13) and then fired and transformed in the rotary kiln (14) and in which said at least one combustion zone comprises the burner or burners (2) of the rotary kiln, and possibly the burner or burners (2′) of the precalcinator.

14. Method according to claim 1, in which the oxygenated gas is air.

15. Method according to claim 1, in which the oxygenated gas is a gas enriched in oxygen, or depleted in oxygen.

16. Continuous clinker production facility (1) having at least one combustion zone (2, 2′) of a fuel for firing an inorganic raw material, designed to transform the raw material into clinker by firing to obtain hot clinker (3), said facility having a first cooler (4) and a second cooler (5) in succession, arranged to cool the hot clinker (3) in two successive steps, a first cooling step being carried out in said first cooler (4) and a second cooling step being carried out in said second cooler (5),
wherein the facility comprises:
a source of oxygenated gas (6) to cool materials in the first cooler (4),
gas lines arranged to convey the entire heated gas generated by the first cooler (4), to said at least one combustion zone (2, 2′) of said facility to be used as combustion gases,
means for adjusting the quantity of oxygenated gas blown to the first cooler so as to cover combustion gas needs of said facility without excess,
and said second cooler (5) comprises means for storage of partially cooled clinker (71) after the first cooling step, said facility comprising means for intermittently controlling said second cooler (5).

17. Facility according to claim 16, comprising a cyclone preheater (12), possibly a precalcinator (13) equipped with one or several burners (2′), and a rotary kiln (14) equipped with one or several burners (2), and in which said at least one combustion zone comprises the burner or burners (2) of the rotary kiln (14), and optionally the burner or burners (2′) of the precalcinator (13).

18. Facility according to claim 16, comprising a device (10, 11) for generating electricity from the heat transferred by the clinker in the second cooler.

19. Facility according to claim 18, wherein the second cooler exchanges heat between the partially cooled clinker (31) and a fluid (9), and in which the electricity generating device comprises a heat exchanger (10) and a turbine (11), the heat exchanger cooperating with the fluid (9′) heated by the clinker to generate steam used to supply said turbine (11).

20. Method according to claim 1, in which in the second step, the clinker is cooled by exchange with a fluid (9) without direct contact between the clinker and the cooling fluid.
